(19) United States
(12) Patent Application Publication
(10) Pub. No.: US 2013/0050414 A1
(43) Pub. Date: Feb. 28, 2013

(54) METHOD AND SYSTEM FOR NAVIGATING AND SELECTING OBJECTS WITHIN A THREE-DIMENSIONAL VIDEO IMAGE

(71) Applicants: Pavel Siniavine, Ricmond Hill (CA); Jitesh Arora, Markham (CA); Alexander Zorin, Aurora (CA); Gabor Sines, Toronto (CA); Xingping Cao, Markham (CA); Philip L. Swan, Richmond Hill (CA); Mohamed K. Cherif, Thornhill (CA); Edward Callway, Toronto (CA)

(72) Inventors: Pavel Siniavine, Ricmond Hill (CA); Jitesh Arora, Markham (CA); Alexander Zorin, Aurora (CA); Gabor Sines, Toronto (CA); Xingping Cao, Markham (CA); Philip L. Swan, Richmond Hill (CA); Mohamed K. Cherif, Thornhill (CA); Edward Callway, Toronto (CA)

(73) Assignee: ATI Technologies ULC, Markham (CA)

(21) Appl. No.: 13/216,940

(22) Filed: Aug. 24, 2011

(51) Int. Cl. H04N 13/00

(52) U.S. Cl. 348/43; 348/E13.001

(57) ABSTRACT

A method and system are provided for navigating and selecting objects within a 3D video image by computing a depth coordinate based upon two-dimensional (2D) image information from left and right views of such objects. In accordance with preferred embodiments, commonly available computer navigation devices and input devices can be used to achieve such navigation and object selection.

### BACKGROUND

The present disclosure relates to three-dimensional (3D) video images, and in particular, to navigating and selecting objects within such images.

As use of 3D video images increases, particularly within video games, the need for an effective way to navigate within such images becomes greater. This can be particularly true for applications other than gaming, such as post-production processing of video used in the creation of 3D movies and television shows. However, translating the movements of a typical computer navigation device, such as a computer mouse, into the 3D space of a 3D video image has proven to be difficult. Accordingly, it would be desirable to have a system and method by which commonly available computer navigation devices can be used to navigate and select objects within a 3D video image.

### SUMMARY OF EMBODIMENTS OF THE INVENTION

An exemplary method and system are disclosed for navigating and selecting objects within a 3D video image by computing a depth coordinate based upon two-dimensional (2D) image information from left and right views of such objects. In accordance with preferred embodiments, commonly available computer navigation devices and input devices can be used to achieve such navigation and object selection.

### BRIEF DESCRIPTION OF THE DRAWINGS

FIG. 1 depicts a system and method for displaying a 3D video image in which navigation and object selection can be achieved in accordance with an exemplary embodiment.

FIG. 2 depicts a geometrical relationship used in computing the depth of an object in 3D space based on left and right views of a stereoscopic image.

FIG. 3 depicts the use of lateral coordinates from left and right views to determine pixel depth.

FIG. 4 depicts stereoscopic detection of a user navigation device for mapping its coordinates within 3D space in accordance with an exemplary embodiment.

FIG. 5 is a flow chart for using pixel coordinate information from left and right views to determine pixel depth.

### DETAILED DESCRIPTION OF PREFERRED EMBODIMENTS

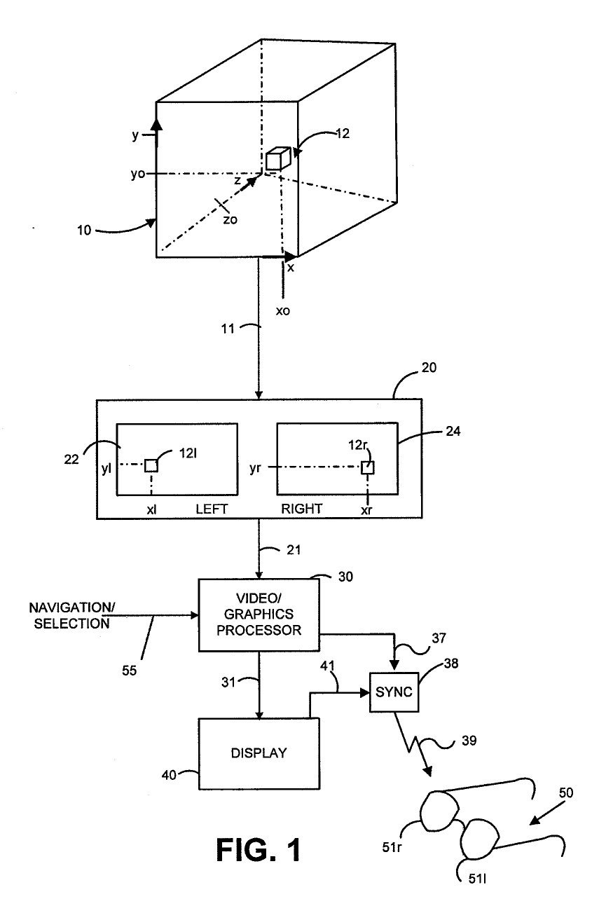

Referring to FIG. 1, a 3D video image includes multiple 3D video frames 10 having width X, height Y and depth Z, within which multiple picture elements, or pixels 12, exist to provide image information. Each pixel 12 will have its own lateral coordinate Xo, height coordinate Yo and depth coordinate Zo. These video frames tend typically to form a video signal 11, which is stored in a suitable storage medium 20, e.g., memory such as magnetic tape, a magnetic disc, flash memory, random access memory (RAM), a DVD, CD-ROM, or other suitable analog or digital storage media.

Such video frames 10 are typically encoded as two-dimensional (2D) video frames 22, 24 corresponding to left 22 and right stereoscopic 24 views. As a result, the original image element, e.g., 3D pixel 12, is encoded as a left pixel 121 and a right pixel 12r having lateral and height coordinate pairs (Xl, Yl) and (Xr, Yr), respectively. The original depth coordinate Zo, as discussed in more detail below, is a function of the distance between the lateral coordinates Xl, Xr of the left 22 and right 24 views.

During playback or display of the video frames, the encoded left 22 and right 24 video frames are accessed, e.g., by being read out from the storage medium 20 as a video signal 21 for processing by a suitable video or graphics processor 30, many types of which are well known in the art. This processor 30 (for which the executable processing instructions can be stored in the storage medium 20 or within other memory located within the host system or elsewhere, e.g., accessible via a network connection), in accordance with navigation/control information 55 (discussed in more detail below) provides a decoded video signal 31 to a display device 40 for display to a user. To achieve the 3D effect, the user typically wears a form of synchronized glasses 50 having left 511 and right 51r lenses synchronized to the alternating left and right views being displayed on the display device 40. Such synchronization, often achieved wirelessly, is done using a synchronization circuit 38 (e.g., by providing a wireless synchronization signal 39 to the glasses 50 in the form of radio frequency or infrared energy) in accordance with a control signal 37, 41 from the processor 30 or display 40.

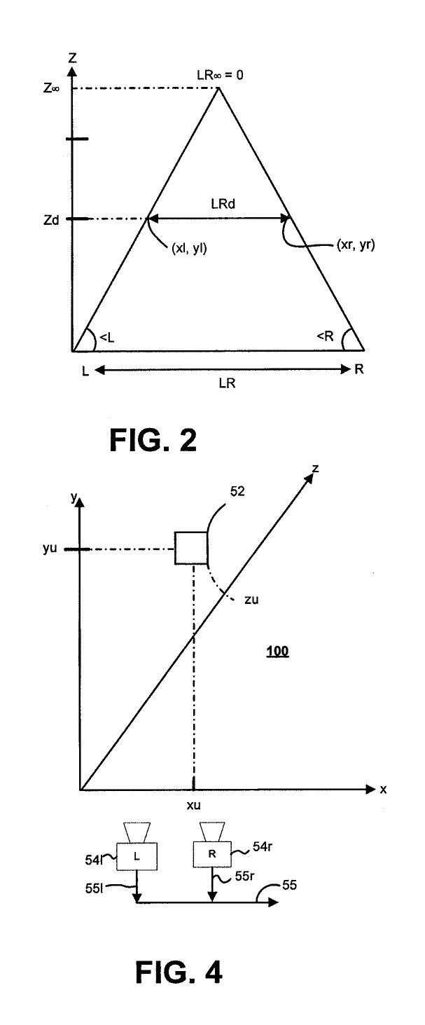

Referring to FIG. 2, in accordance with well known geometrical principals, the distance or depth Zd of an object in 3D space can be determined based on image information from left L and right R stereoscopic views. The apex of the triangle as illustrated represents the maximum depth Zoo of the video frame, e.g., where the difference Xl−Xr between the lateral image coordinates Xl, Xr equals zero is at infinity, and the base of the triangle represents the minimum depth Z0 of the video frame, e.g., where the difference Xl−Xr between the lateral image coordinates Xl, Xr equals the maximum width of the viewable space. Accordingly, within the defined 3D image space, each pixel of an object being viewed will have a left lateral and height coordinate pair (Xl, Yl) and a right lateral and height coordinate pair (Xr, Yr), with each having associated therewith a depth coordinate Zd. As a result, the left view for a given image pixel will have a left lateral, height and depth coordinate set (Xl, Yl, Zd), and a corresponding right lateral, height and depth coordinate set (Xr, Yr, Zd).

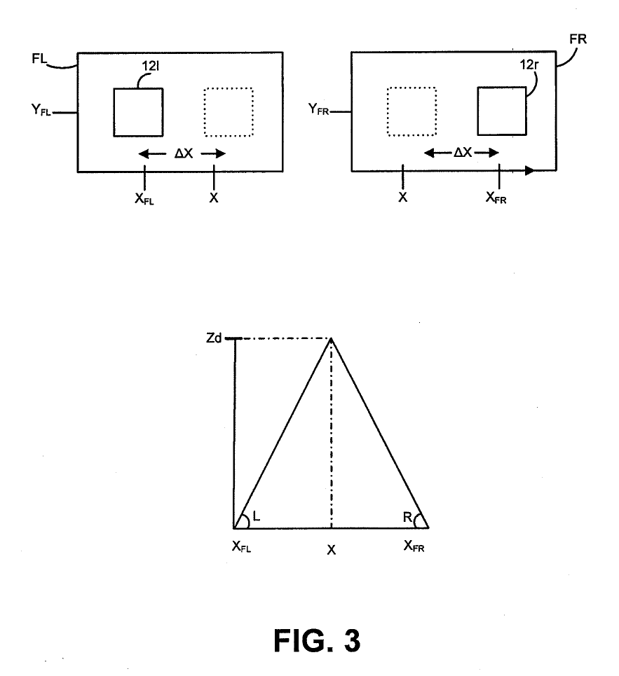

Referring to FIG. 3, corresponding left 121 and right 12r pixels have pixel coordinates (X_{FL}, Y_{FL}) and (X_{FR}, Y_{FR}), respectively. Depth information is a function of the distance ΔX (the difference X_{FL}-X_{FR} between the lateral image coordinates X_{FL}, X_{FR}) between the left 121 and right 12r frame pixels. In accordance with well-known geometrical principals, the central lateral coordinate X for the base of the triangle for finding the depth Zd can be computed: X=X_{FL}+ΔX/2=X_{FR}−ΔX/2. The vertical coordinates are equal: Y=Y_{FL}=Y_{FR}. The depth Zd can then be computed: Zd=2*ΔX*tan∠L=2*ΔX*tan∠R.

Referring to FIG. 4, in accordance with an exemplary embodiment, the navigation/selection information 55 for processing by the processor 30 (FIG. 1) in conjunction with the video information 21 can be provided based on stereoscopic image information 551, 55r captured by left 541 and right 54r video image capturing devices (e.g., cameras) directed to view the three-dimensional space 100 within which a pointing device 52 is manipulated by a user (not shown). Such pointing device 52, as it is manipulated and moved about within such space 100, will have lateral Xu, height Yu and depth Zu coordinates. As discussed above, the image capturing devices 541, 54r will capture stereoscopic left and right images of the pointing device 52 with each such image having associated left and right lateral and height coordinate pairs (Xul, Yul), (Xur, Yur). As also discussed above, based on these coordinate pairs (Xul, Yul), (Xur, Yur), the corresponding depth coordinate Zu can be computed.

In accordance with well known principles, the minimum and maximum possible coordinate values captured by these image capturing devices 541, 54r are scaled and normalized to correspond to the minimum and maximum lateral (MIN(X) and MAX(X)), height (MIN(Y) and MAX(Y)) and depth (MIN(Z)=Z0 and MAX(Z)=Z∞) coordinates available within the 3D image space 10 (FIG. 1). As a result, a stereoscopic image of the pointing device can be placed within the 3D video frame 10 (FIG. 1) at the appropriate location within the frame. Accordingly, as the user-controlled pointing device 52 is moved about within its 3D space 100, the user will be able to navigate within the 3D space 10 of the video image as shown on the display device 40.

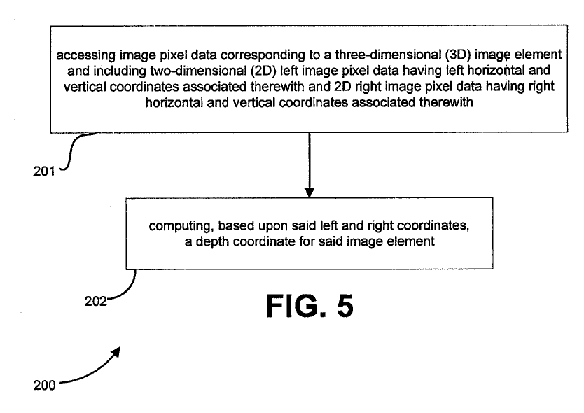

Referring to FIG. 5, a method 200 in accordance with an exemplary embodiment begins at process 201 by accessing image pixel data corresponding to a three-dimensional (3D) image element and including two-dimensional (2D) left image pixel data having left horizontal and vertical coordinates associated therewith and 2D right image pixel data having right horizontal and vertical coordinates associated therewith. This is followed by process 202 computing, based upon said left and right coordinates, a depth coordinate for said image element.

Additionally, integrated circuit design systems (e.g., work stations with digital processors) are known that create integrated circuits based on executable instructions stored on a computer readable medium including memory such as but not limited to CDROM, RAM, other forms of ROM, hard drives, distributed memory, or any other suitable computer readable medium. The instructions may be represented by any suitable language such as but not limited to hardware descriptor language (HDL) or other suitable language. The computer readable medium contains the executable instructions that when executed by the integrated circuit design system causes the integrated circuit design system to produce an integrated circuit that includes the devices or circuitry as set forth herein. The code is executed by one or more processing devices in a work station or system (not shown). As such, the devices or circuits described herein may also be produced as integrated circuits by such integrated circuit design systems executing such instructions.

What is claimed is:

1. A method comprising:
accessing image pixel data corresponding to a three-dimensional (3D) image element and including two-dimensional (2D) left image pixel data having left horizontal and vertical coordinates associated therewith and 2D right image pixel data having right horizontal and vertical coordinates associated therewith; and
computing, based upon said left and right coordinates, a depth coordinate for said image element.

2. The method of claim 1, wherein said computing, based upon said left and right coordinates, a depth coordinate for said image element comprises computing said depth coordinate for said image element based upon said left and right horizontal coordinates.

3. The method of claim 1, wherein said computing, based upon said left and right coordinates, a depth coordinate for said image element comprises computing said depth coordinate for said image element in accordance with a difference between said left and right coordinates.

4. The method of claim 1, wherein said computing, based upon said left and right coordinates, a depth coordinate for said image element comprises computing said depth coordinate for said image element in accordance with a difference between said left and right horizontal coordinates.

5. An apparatus including circuitry, comprising:
programmable circuitry for
accessing image pixel data corresponding to a three-dimensional (3D) image element and including two-dimensional (2D) left image pixel data having left horizontal and vertical coordinates associated therewith and 2D right image pixel data having right horizontal and vertical coordinates associated therewith, and
computing, based upon said left and right coordinates, a depth coordinate for said image element.

6. The apparatus of claim 5, wherein said programmable circuitry is for computing said depth coordinate for said image element based upon said left and right horizontal coordinates.

7. The apparatus of claim 5, wherein said programmable circuitry is for computing said depth coordinate for said image element in accordance with a difference between said left and right coordinates.

8. The apparatus of claim 5, wherein said programmable circuitry is for computing said depth coordinate for said image element in accordance with a difference between said left and right horizontal coordinates.

9. An apparatus, comprising:
memory capable of storing executable instructions; and
at least a first processor operably coupled to said memory and responsive to said executable instructions by
accessing image pixel data corresponding to a three-dimensional (3D) image element and including two-dimensional (2D) left image pixel data having left horizontal and vertical coordinates associated therewith and 2D right image pixel data having right horizontal and vertical coordinates associated therewith, and
computing, based upon said left and right coordinates, a depth coordinate for said image element.

10. The apparatus of claim 9, wherein said at least a first processor is responsive to said executable instructions by computing said depth coordinate for said image element based upon said left and right horizontal coordinates.

11. The apparatus of claim 9, wherein said at least a first processor is responsive to said executable instructions by computing said depth coordinate for said image element in accordance with a difference between said left and right coordinates.

12. The apparatus of claim 9, wherein said at least a first processor is responsive to said executable instructions by computing said depth coordinate for said image element in accordance with a difference between said left and right horizontal coordinates.

13. A computer readable medium comprising a plurality of executable instructions that, when executed by an integrated circuit design system, cause the integrated circuit design system to produce:
an integrated circuit (IC) including programmable circuitry for
accessing image pixel data corresponding to a three-dimensional (3D) image element and including two-dimensional (2D) left image pixel data having left horizontal and vertical coordinates associated therewith and 2D right image pixel data having right horizontal and vertical coordinates associated therewith, and
computing, based upon said left and right coordinates, a depth coordinate for said image element.

14. The apparatus of claim 13, wherein said programmable circuitry is for computing said depth coordinate for said image element based upon said left and right horizontal coordinates.

15. The apparatus of claim 13, wherein said programmable circuitry is for computing said depth coordinate for said image element in accordance with a difference between said left and right coordinates.

16. The apparatus of claim 13, wherein said programmable circuitry is for computing said depth coordinate for said image element in accordance with a difference between said left and right horizontal coordinates.
